(19) United States
(12) Patent Application Publication
(10) Pub. No.: US 2025/0073855 A1
(43) Pub. Date: Mar. 6, 2025

(54) VEHICULAR ACCESSORY GRIP

(71) Applicant: Bombardier Recreational Products, Inc., Valcourt (CA)

(72) Inventors: Felix Savoie, Sherbrooke (CA); Remi Larrouy, Sherbrooke (CA); Julien Chayer-Veillette, Valcourt (CA); Michel Bourassa, Sherbrooke (CA)

(21) Appl. No.: 18/821,120

(22) Filed: Aug. 30, 2024

Related U.S. Application Data
(60) Provisional application No. 63/579,821, filed on Aug. 31, 2023.

(51) Int. Cl. B25B 7/02

(52) U.S. Cl. CPC B25B 7/02

(57) ABSTRACT

A gripping mechanism may comprise a relatively resilient endoskeleton having at least one opening through its thickness and a relatively flexible elastomer embedding the relatively resilient endoskeleton therein. Additionally, an exemplary gripping mechanism may be configured such that the elastomer has at least one portion that passes through the at least one opening in the U-shaped endoskeleton and at least one portion of the endoskeleton is exposed through the elastomer coating.

### RELATED APPLICATIONS

This application is a non-provisional patent application claiming the benefit of priority of U.S. Provisional Patent Application Ser. No. 63/579,821, filed on Aug. 31, 2024, the entire disclosures of which are incorporated herein by reference in its entirety.

### FIELD OF THE INVENTION

The present invention relates to gripping mechanisms for recreational vehicles, in particular, all-terrain, and side-by-side vehicles as well as others whose use involves rough or rugged land, water, ice, snow, or other similar turbulent terrain conditions.

### BACKGROUND

While devices have been made to grip objects, such as those described in EP2735409 A1, their mechanisms and means of operation make them ill-suited for gripping objects.

Additionally, gripping mechanisms for holding items on recreational vehicles must be a balance of utility in terms of holding forces and space in terms of amount of the vehicle such mechanism occupy. While there are many gripping mechanisms that provide rigid holding arrangements for items and accessories, these mechanisms tend to take up large space on the vehicles on which it is used or otherwise occupy locations on the vehicle that would be better served for other purposes.

A need exists for a more optimal accessory or other article gripping mechanism that is both convenient to use, sufficient for providing balance and rigidity in its hold, maintains the article in its position with concern of being loosened or falling out of its holding pattern, and conserve space on the recreational vehicle on which it is used.

### SUMMARY

An exemplary vehicular accessory gripping mechanism may comprise a relatively resilient U-shaped endoskeleton and a relatively flexible elastomer embedding the relatively resilient U-shaped endoskeleton therein. An exemplary vehicular accessory gripping mechanism may be configured such that the gripping mechanism comprises a first jaw formed from the relatively flexible elastomer that contains one part of the U-shaped endoskeleton and a second jaw formed from the relatively flexible elastomer that contains an opposing part of the U-shaped endoskeleton.

In addition to the previously described embodiment and/or as an alternative to any other described exemplary embodiment, an exemplary vehicular accessory gripping mechanism may further comprise a sprocket between two portions of the U-shaped endoskeleton and also embedded within the elastomer.

In addition to the previously described embodiment and/or as an alternative to any other described exemplary embodiment, an exemplary vehicular accessory gripping mechanism may further comprise a web in which the sprocket is embedded and to which each of the elastomer material comprising the first jaw and the second jaw is integrally joined.

In addition to the previously described embodiment and/or as an alternative to any other described exemplary embodiment, an exemplary vehicular accessory gripping mechanism may further comprise a tongue integrally molded to one of the first jaw and the second jaw.

In addition to the previously described embodiment and/or as an alternative to any other described exemplary embodiment, an exemplary vehicular accessory gripping mechanism may further comprise a hook integrally molded to whichever one of the first jaw and the second jaw does not have the tongue.

In addition to the previously described embodiment and/or as an alternative to any other described exemplary embodiment, an exemplary vehicular accessory gripping mechanism may further comprise a sprocket located at a bending point around which the first jaw and the second jaw bend and being embedded in the relatively flexible elastomer between at least two parts of the relatively resilient U-shaped endoskeleton, wherein the first jaw and the second jaw each comprises a plurality of ribs interconnecting a first surface to a mouth, and the first jaw comprises a tongue and the second jaw comprises a hook configured to engage with the tongue to cause the first jaw and the second jaw to bend about the embedded sprocket.

In addition to the previously described embodiment and/or as an alternative to any other described exemplary embodiment, an exemplary vehicular accessory gripping mechanism may further comprise a sprocket located at a pivoting point around which the first jaw and the second jaw pivot and being embedded in the relatively flexible elastomer between at least two parts of the relatively resilient U-shaped endoskeleton, wherein the first jaw and the second jaw each comprises a plurality of ribs interconnecting a first surface to a mouth, and the first jaw comprises a tongue and the second jaw comprises a hook configured to engage with the tongue to cause the first jaw and the second jaw to pivot about the embedded sprocket.

In addition to the previously described embodiment and/or as an alternative to any other described exemplary embodiment, an exemplary vehicular accessory gripping mechanism may be configured such that the elastomer has a V-shaped configuration.

In addition to the previously described embodiment and/or as an alternative to any other described exemplary embodiment, an exemplary vehicular accessory gripping mechanism may be configured such that the relatively resilient U-shaped endoskeleton further comprises at least one opening through its thickness and wherein the elastomer has at least one portion that passes through the at least one opening in the U-shaped endoskeleton.

In addition to the previously described embodiment and/or as an alternative to any other described exemplary embodiment, an exemplary vehicular accessory gripping mechanism may be configured such that the first jaw and the second jaw are configured to flex toward one another by bending a portion of the U-shaped endoskeleton that couples the one part to the opposing part.

In addition to the previously described embodiment and/or as an alternative to any other described exemplary embodiment, an exemplary vehicular accessory gripping mechanism may be configured such that the bending joint comprises a sprocket between the one part and the opposing part of the U-shaped endoskeleton.

In addition to the previously described embodiment and/or as an alternative to any other described exemplary embodiment, an exemplary vehicular accessory gripping mechanism may be configured such that the first jaw and the second jaw are configured to flex toward one another by pivoting a portion of the U-shaped endoskeleton that couples the one part to the opposing part.

In addition to the previously described embodiment and/or as an alternative to any other described exemplary embodiment, an exemplary vehicular accessory gripping mechanism may be configured such that the pivoting joint comprises a sprocket between the one part and the opposing part of the U-shaped endoskeleton.

In addition to the previously described embodiment and/or as an alternative to any other described exemplary embodiment, an exemplary vehicular accessory gripping mechanism may be configured such that the first jaw comprises a plurality of ribs interconnecting a first surface to a mouth.

In addition to the previously described embodiment and/or as an alternative to any other described exemplary embodiment, an exemplary vehicular accessory gripping mechanism may be configured such that the second jaw comprises a plurality of ribs interconnecting a first surface to a mouth.

In addition to the previously described embodiment and/or as an alternative to any other described exemplary embodiment, an exemplary vehicular accessory gripping mechanism may be configured such that at least one portion of the U-shaped endoskeleton is exposed through the elastomer coating.

In addition to the previously described embodiment and/or as an alternative to any other described exemplary embodiment, an exemplary vehicular accessory gripping mechanism may be configured such that each of the plurality of ribs is angled with respect to the mouth of the respective first jaw and second jaw in which it is found.

In addition to the previously described embodiment and/or as an alternative to any other described exemplary embodiment, an exemplary vehicular accessory gripping mechanism may be configured such that each of the plurality of ribs is angled at an angle no greater than about 90 degrees.

In addition to the previously described embodiment and/or as an alternative to any other described exemplary embodiment, an exemplary vehicular accessory gripping mechanism may be configured such that each of the plurality of ribs is angled at an angle no greater than about 60 degrees.

In addition to the previously described embodiment and/or as an alternative to any other described exemplary embodiment, an exemplary vehicular accessory gripping mechanism may be configured such that each of the plurality of ribs is angled at an angle no greater than about 45 degrees.

In addition to the previously described embodiment and/or as an alternative to any other described exemplary embodiment, an exemplary vehicular accessory gripping mechanism may be configured such that the first jaw and the second jaw are more proximal to one another when the tongue is engaged to the hook as compared to when the tongue is disengaged from the hook.

### DESCRIPTION OF THE DRAWINGS

FIG. 1 illustrates an exemplary isometric view of an exemplary vehicular accessory gripping mechanism with a rotational component shown transparently.

FIG. 2 illustrates an exemplary profile view of components of an exemplary vehicular accessory gripping mechanism.

Each of FIGS. 3A-B illustrates an exemplary topographic view of opposite sides of an exemplary vehicular accessory gripping mechanism.

FIG. 4A illustrates an exemplary embodiment of an isometric view of an exemplary vehicular accessory gripping mechanism with a portion made transparent to show internal components.

FIG. 4B illustrates another exemplary embodiment of an isometric view of an exemplary vehicular accessory gripping mechanism with multiple portions made transparent to show internal components.

FIG. 5 illustrates an exemplary embodiment of a profile view of an exemplary vehicular accessory gripping mechanism with multiple portions made transparent to show internal components.

Each of FIGS. 6-7 illustrates an exemplary embodiment of isometric views of an internal component for use within an exemplary vehicular accessory gripping mechanism.

FIG. 8 illustrates an alternative exemplary embodiment of an isometric view of an internal component for use with another exemplary vehicular accessory gripping mechanism.

FIG. 9 illustrates an alternative exemplary embodiment of an isometric view of another variant of an exemplary vehicular accessory gripping mechanism with the internal component of FIG. 8.

FIG. 10 illustrates an exemplary profile view of the exemplary vehicular accessory gripping mechanism of FIG. 9.

FIG. 11 illustrates an exemplary topographic view of an exemplary vehicular accessory gripping mechanism of FIG. 9.

In the drawings like characters of reference indicate corresponding parts in the different and interchangeable and interrelated figures. Parts and components of each figure may be substitutes for other components in other figures to achieve the various methods and embodiments disclosed herein. Methods and protocols disclosed in any embodiment may be run in any order so as to affect their disclosed goals and/or enable performance of the systems as described. Additionally, any one embodiment may utilize any method or protocol described and in any portions, sequences, and combinations thereof.

### DETAILED DESCRIPTION

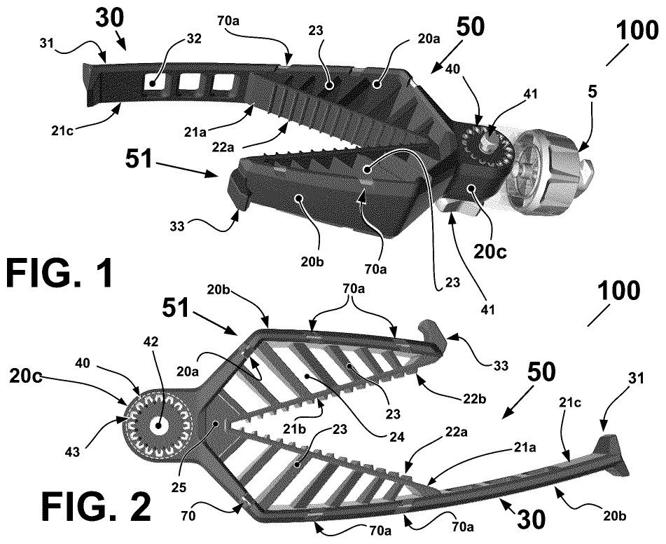

Referring to FIGS. 1-2 and 3A-B, an exemplary vehicular accessory gripping mechanism (“VAGM”) 100 may be illustrated. In a first embodiment, an exemplary VAGM 100 may comprise a vehicle body interface 5, which may be any form of ratcheting, rotating, hinged, or other mechanically connectable part that enables an exemplary VAGM 100 to attach to a particular vehicle in which it is to be used. An exemplary vehicle body interface 5 may be further coupled to an adjustable wrist mount 6, which may be manually adjustable to bend or pivot to different angles and directions using a bending means, such as a screw-fastener 41, or like pivoting means. An exemplary VAGM 100 may further comprise a top jaw 50 and a bottom jaw 51, although the words “top” and “bottom” do not require a particular spatial orientation. In an exemplary embodiment, an exemplary upper jaw 50 and/or lower jaw 51 may have an inner surface 20a and an outer surface 20b. Each inner surface 20a of its respective upper jaw 50 and lower jaw 51 may have a plurality of alternating ribs 23 and spaces 24 interconnecting the inner surface 20a to a mouth 21, which is mouth 21a in upper jaw 50 and mouth 21b in lower jaw 51. In upper jaw 50, extending away from inner surface 20a and/or from the inner-most surface of mouth 21a may be a plurality of teeth 22a. In lower jaw 51, extending away from the inner surface 20a and/or from the inner-most surface of mouth 21b may be a plurality of teeth 22b.

According to an exemplary embodiment as illustrated in FIGS. 1-2 and 5, the outer surfaces 20b of the upper jaw 50 and lower jaw 51 of VAGM 100 may be integrally molded to one another about a hub 20c that houses a fulcrum 40 for the resilient flexing of jaws 50/51 about an object (not shown). Referring to the same exemplary embodiment of FIGS. 1-2 and 5, the inner surfaces 20a, ribs 23, and mouths 21a/21b may each collectively terminate at a web 25 proximal the fulcrum 40 of the VAGM 100. In an exemplary embodiment, an axis 42 may pass through an opening in the thickness of an exemplary VAGM 100 at the fulcrum 40 to allow for use of screw-tightening fasteners, such as fastener 41, to lock the VAGM 100 in a particular angular position vis-à-vis the body interface 5 and, therefore, the vehicle to which it is attached. As may be further illustrated in FIGS. 1-2 and 3A-B, a tongue 30 may be shown as an extension of the outer surface 20b of upper jaw 50 with a corresponding inner extension surface 21c through each of which there may be one or more rings 32. In use, rings 32 may be designed to receive hook 33 disposed on lower jaw 51 so that when lip 31 of tongue 30 is pulled toward the hook 33, engagement of the appropriate ring 32 and hook 33 may result in a relatively locked VAGM 100, i.e., the VAGM 100 jaws 50/51 may be said to “bite” an object found between them.

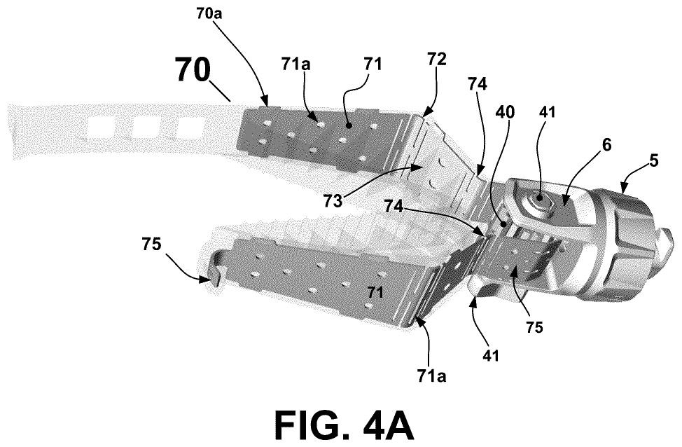

As maybe further illustrated in FIGS. 1-2, 3A-B, and 5, metallic tabs 70a belonging to a metal framework within the VAGM 100 components, e.g., jaws 50/51, may be observable to the user. In an exemplary embodiment, metallic tabs 70a may be remnants of the over-molding process ideally suited for fabricating an exemplary VAGM 100. A similar remnant may be observed with embedded sprocket 43 whose axis is shared with fulcrum axis 42, although sprocket 43 is not meant to rotate within VAGM 100, but to provide a stable bend and/or pivot and/or deflection point for the up and down flexing of the remainder of endoskeleton 70 and, concurrently, the remainder of the jaws 50/51 in which the same is embedded. For a more detailed view of these remnants as they may appear in a finished jaw 50/51, reference may be made to FIGS. 4A-B. In a preferred embodiment, the material used for the over-molding process that leads to formation of VAGM 100 may include rubber, in particular, vulcanized rubber, although it is contemplated that other suitable elastomers and resilient rubbers may be used as long as their material and mechanical properties are consistent with the teachings of operation herein disclosed.

Accordingly, the jaws 50/51 comprise relatively resilient portions and relatively flexible portions. The relatively resilient portions of an exemplary jaw 50/51 may be considered those portions that have therein over-molded resilient material, e.g., steel, plastic, metals. An exemplary relatively resilient portion of a jaw 50/51 would be the thickness of VAGM 100 that lay between outer surface 20b and inner surface 20a. Another exemplary relatively resilient portion may be fulcrum 40, which is a portion of VAGM 100 that has within it an over-molded sprocket 43. Another exemplary relatively resilient portion may be hook 33, which may be an over-molded structure. In contrast, the following features would be considered relatively flexible portions of an exemplary jaw 50/51: (i) ribs 23, (ii) mouth 21a/21b, (iii) teeth 22a/22b, (iv) web 25, (v) tongue 30, and (vi) lip 31.

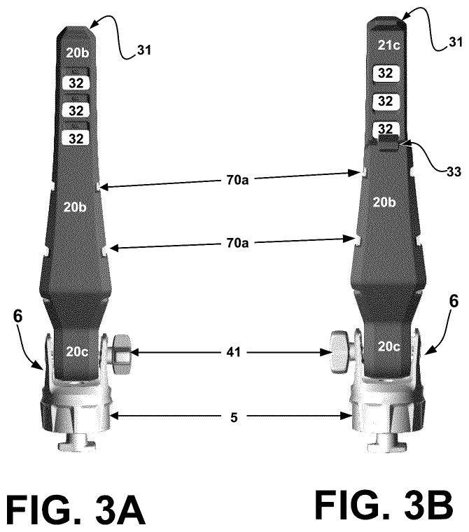

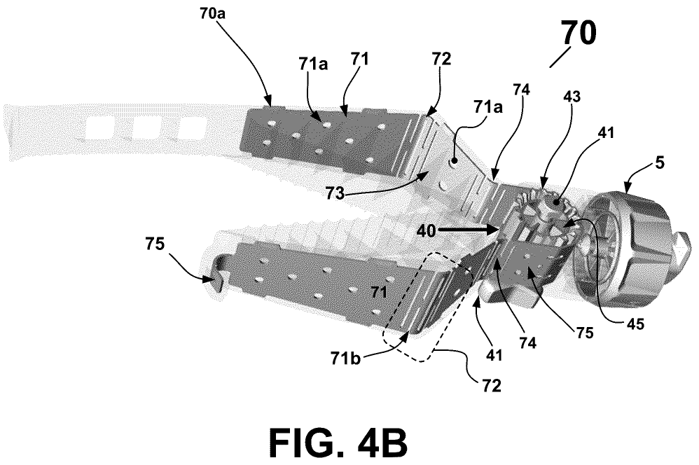

The relatively flexible ribs 23 may act like a combination of a spring and a dampener when an object or accessory is placed between jaws 50 and 51 for retention by the same. It may be understood that the deflection of each rib 23 when impacted by the object (not shown) found between the jaws 50/51 of the exemplary VAGM 100 may allow that rib 23 to act as both a pressure inducer (e.g., due to its material desire to resume its more straightened formation) and a motion dampener (e.g., due to its deformed formation that can absorb vibration and shock loads on the held object due to movement of the vehicle and/or other disturbances). The spaces 24 between ribs 23 may vary in size and shape (e.g., not always trapezoidal as imaged in the FIGS. 2 and 5), to allow for an ideal pressure inducement capability in ribs 23 and dampening capability of the ribs 23. It may also be appreciated that while each rib 23 may be angled substantially the same with respect to each adjacent rib and/or the mouth 21a/21b of the particular jaw 50/51, respectively, in which it may be found, there is no requirement that this be the case.

With particular reference to FIG. 5, an exemplary rib 23 may be at an angle 26 with respect to a line 20x1, which may be located along center of the thickness of the mouth 21a of upper jaw 50. While angle 26 may be shown as an acute angle, it may be any angle configured to achieve the desired results of holding a vehicular accessory against the forces and vibrations experienced during transit in a vehicle. In a preferred embodiment, angle 26 is greater than 0° but no greater than 90°. In another preferred embodiment, angle 26 may be between 5° and 85°, more preferably, between 15° and 75°, even more preferably between 30° and 70°, even more preferably between 45° and 65°, and still more preferably, between 55° and 60°. Alternatively, any of the aforementioned angle 26 values may change depending on the thickness of ribs 23, the shape and size of spaces 24, and the material used in tibs 23. In other words, a more elastically resilient material combined with thicker ribs 23 with smaller sized spaces 24 may require a more “steep” angle 26 as compared to a thinner “gauge” rib 23 with larger spaces 24. Additionally, while angle 26 has been identified with reference to upper jaw 50, a similar angular determination may be obtained by looking to the angle of ribs 23 with respect to a line 20x2 passing through the center of thickness of mouth 21b of jaw 51.

In an exemplary embodiment, when an object is located between upper jaw 50 and lower jaw 51 and is clamped between the jaws 50/51 using tongue 30 and hook 35, one or more ribs 23 located below the object may wrinkle or deform in response to the closure and one or more ribs 23 above the object may remain substantially unwrinkled and/or undeformed in response to the closure, while being bent such that the ribs are angled in a direction opposite the direction which the object would have to move within the jaws. Thus, the combination of deflected and undeflected ribs 23 may further enhance the gripping mechanism's capability to retain an object against movement in multiple directions.

In another exemplary embodiment to be described with reference to FIG. 5, an exemplary VAGM 100 may have a jaw 50 having a plurality of ribs 23a, 23b, 23c, 23d, 23c, and 23f. In a first variation of this embodiment, an object having a cross-section whose major diameter is no larger than the distance between the vertex formed by the lines 20x1 and 20x2 and the rib 23b. According to this first variation, when such an object is enclosed within an exemplary VAGM 100 using the cells 32 on hook 33, ribs 23a-c may experience deflection as a result

As previously described, teeth 22a and 22b may be aligned along the upper mouth 21a and lower mouth 21b, respectively, in any arrangement designed to affect adequate holding to as many cross-sections as possible. As illustrated, in FIGS. 1-2 and 5, teeth 22a/22b may take on the form of repeating arrays of triangular ridges followed by a flat ridge therebetween. Other geometric arrays may also be considered and are suitable if those skilled in the art would deem such geometric arrays an option for holding a particular object or objects. Additionally, teeth 22a and 22b may be configured to mate with one another to provide an additional retention benefit to the jaws 50/51 when closed about an object cross-section. For example, teeth 22a may be hollow triangular structures similar to the rib 23 and space 24 arrangement within the jaws 50/51 to flex in response to an object cross-section but apply resilient pressure to the same when jaws 50 and 51 close about the same.

With continued reference to FIG. 5, an exemplary top jaw 20a and an exemplary bottom jaw 20b may be substantially mirror reflections of one another along a line that bisects angle 27. is perpendicular to axis 42 and bisects the angle formed between the mouth 21a of jaw 20a and the mouth 21b of jaw 20b. The angle 27 between the jaws 50 and 51 is not critical, although it may be imagined that a too-narrow angle 27 or a too wide angle 27 may be detrimental for handling a large variety of different objects without also requiring increased mechanical properties from the remainder of the VAGM 100.

Turning attention to FIGS. 4A-B and FIGS. 5-7, an exemplary internal componentry of an exemplary VAGM 100 may be illustrated. The tabs 70a that may be visible through the material making up jaws 50/51 may now be understood as tabs of an endoskeleton 70. An exemplary endoskeleton has hands 71, wrists 72, and arms 73 that together act as the backbone of each jaw 50 and 51 in the VAGM 100. A series of openings 71a and slats 71b may be found on the endoskeleton 70 to allow for injection-molded material (e.g., rubber or another elastomer), to flow through and engulf the endoskeleton 70 firmly and substantially non-removably within the VAGM 100. In addition to enabling the embedding functionality of the endoskeleton 70 with the rest of the VAGM 100, the openings 71a may reduce the weight of the resilient endoskeleton 70 material, which in an embodiment is a 1.2 mm thick spring steel, as well as add more deflectability to the endoskeleton 70 at those portions where such deflection capability is necessary, e.g., wrist 72 and shoulders 74, which form the outer-most parts of the C-bracket comprised of clamp faces 75 and clamp vertex 76. In a preferred embodiment, slats 71b may be alternating open and closed cellular structures with fine openings meant to induce more flexibility into the steel material of an exemplary endoskeleton 70.

With continued reference to FIGS. 4A-B, an exemplary endoskeleton 70 may further comprise a cliff 77 that may be over molded to form the hook 35 of exemplary VAGM 100. As may be further seen in FIGS. 6-7, an exemplary cliff 77 may also have a slat through its thickness to ensure proper embedding within the appropriate flexibility resilient material of the remainder of jaw 51. Additionally, while the shapes of the various endoskeleton 70 components may be illustrated as trapezoidal and/or rectangular, any shape capable of effecting the desired results described herein may be considered and implemented without use of routine skill. As may be more clearly depicted in FIGS. 4B and 5, the C-bracket portion of endoskeleton 70 may be a part of the fulcrum 40 of an exemplary VAGM 100, which may now be shown more clearly as parts 74, 75, and 76, which may be substantially in close circumferential contact with sprocket 43 having sprocket web 45 extending in the axial direction from one side of sprocket 43 to the other.

With continued reference on those embodiments which show the endoskeleton 70 of an exemplary VAGM 100, the vacancies formed between the endoskeleton 70 components (71, 72, 73, 74, 75, and 76) and those formed in the sprocket 43, including between sprocket web 45, may maximize the ability of the injection-molded flexible material to invade and sufficiently fill in the endoskeleton 70 and fulcrum system 40. The portions of flexible material that span the part of the C-bracket portion going towards the hands 71 of the exemplary VAGM 100 may become part of the web 25 and together form what may be best described as a flexible vertex. Accordingly, embedded sprocket 43 may cooperate with the C-bracket portions 74-76 of endoskeleton 70 to enable jaws 50 and 51 to achieve substantial closure, e.g., angle 27 equaling to substantially zero, without the use of rotational joints or hinges or the jaws having to slip past one another in different planes (e.g., like scissors). In this way, the flexible vertex of VAGM 100 may allow for a reduced profile while maintaining the same desired functionality for gripping an object.

As may be provided in the illustrative embodiments of the endoskeleton 70 depicted in FIGS. 6-7, an exemplary endoskeleton 70 may have a plurality of openings 71a located on every substantially planar face and a plurality of slats 71b on every substantially curved face. Again, utilization of slats 71b may be combined with use of openings 71a and vice versa on any face of endoskeleton 70 provided use of the same allows for a comparatively increased degree of flexibility at the non-planar surfaces and a comparatively increased degree of rigidity along the planar surfaces. As may also be shown, tabs 70a may be found on multiple surfaces (planar or non-planar) to allow the endoskeleton 70 to be held on a surface and over-molded with the flexible material during an exemplary manufacture operation along with the sprocket 40, which would be located within the C-clamp bracket formed by portions 74, 75, and 76 of endoskeleton 70.

As may be illustrated in one or more of FIGS. 1-7, the sprocket 43 embedded within the material making up the jawed portion of VAGM 100 may be used as a fulcrum 40 for the cantilevering of jaws 50/51 about an object but may double as a rotational joint for movement of the jawed portion of VAGM 100 relative to the surface on which it may be installed, i.e., a vehicle. An exemplary wrist mount 6 may frictionally couple the sprocket 43 to itself using a screw-tightening mechanism 41, which was previously shown and described with respect to FIGS. 2, 3A-B, and 4A. By combining wrist mount 6 and sprocket 43 with the exemplary body interface 5 previously described, an exemplary VAGM 100 may be capable of revolutions in orthogonal planes to maximize the versatility and positioning of the jawed portions with respect to a particular object.

In an exemplary embodiment, the size and thickness of the cells 32 along surface 21c of tongue 30 may be such to allow the tongue 30 to engage the hook 35 and remain wrapped or held around the same in all foreseen environments in which VAGM 100 may be used. In another exemplary embodiment, the size, thickness, and location of the cells 32 along surface 21c of tongue 30 may be such that each cell 32 may correspond to a percentage closure of the jaws 50 and 51, e.g., a percentage change in angle 27. For example, by placing hook 35 into the cell 32 most proximal to mouth 21a may result in the most minimal angle 27, e.g., substantially 0°. According to an exemplary embodiment, the most minimal angle 27 may be reserved for objects with cross-sections of a smaller size and/or cross-sections that are to be held at positions closer to the middle of the jaws 50/51, such as, for example, at positions more proximal to ribs 23b and/or 23c as opposed to positions more proximal to only rib 23a. In an alternative embodiment, by placing hook 35 into the cell most distal to mouth 21a, that is, a position most proximal to lip 31, a resulting angle 27 may be substantially maximized. According to an exemplary embodiment, the maximal angle 27 may be reserved for objects with large cross-sections and/or a plurality of objects being held in the VAGM 100 simultaneously. In other words, a VAGM 100 tasked with holding a variety of structures next to one another at the same time may take advantage of the flexible retention capabilities of the rib 23 and mouth 21a/b structures comprising jaws 50/51.

Many further advantages may be derived from the disclosures related to VAGM 100. For example, an exemplary jaw 50/51 may be able to rigidly hold objects of a variety of cross-sections to the same degree regardless of whether the cross-section is round, e.g., circular, elliptical, or some other polygon, e.g., square, trigonal, diamond. Further, due to the flexible nature of ribs 23, an exemplary VAGM 100 may hold one object cross-section between two of the plurality of ribs, e.g., ribs 23a and 23b as illustrated in FIG. 5, and then hold another object cross-section between a different plurality of ribs, e.g., ribs 23d-23f, simultaneously with the same degree of holding but without the rigid hold applied to one object substantially interfering with the rigid hold applied to the other at a distal location within VAGM 100. Another advantage of an exemplary VAGM 100 may be that the resilient endoskeleton 70 may provide for repeated use of the jaws 50/51 without substantial wear to the same from opening and closing operations. Further, the embedded cliff 77 of the endoskeleton 70 may ensure that tongue 30 may be able to be engaged to a substantially rigid structure that will not yield to unclamping during use of VAGM 100.

As described, the relatively flexible portions of VAGM 100 may be made of an elastomer, such as rubber, and may also be embed within such elastomers strengthening materials such as fibers, and filaments, and may include elastomers that undergo strengthening processes, such as stiffness increases using vulcanization. Alternatively, a portion of VAGM 100 may be made of one elastomer, e.g., jaws 50/51, while another portion of VAGM 100 may be made of another elastomer, e.g., tongue 30.

In an exemplary embodiment of an injection molding methodology, an exemplary endoskeleton 70 and sprocket 43 may be placed within a mold such that the axis 42 of the sprocket 43 may be held in place via retention mold pieces that pass either through axis 42 and/or sprocket web 44. Endoskeleton 70 may be held within the mold along retention points for tabs 70a, e.g., indents or channels found within the mold surface. As such, when the opposing mold is closed about the sprocket 43 and endoskeleton 70, the elastomer injected may form about the openings 71a, 71b of endoskeleton 70 and the non-supported portions of sprocket web 44 to create a single integrated structure having a tongue 30 flexibly coupled thereto. In this exemplary way, an exemplary VAGM 100 as shown and described may be formed, although those skilled in the art may devise similar methods along the same lines to achieve the results illustrated and exemplified herein.

In an alternative embodiment, a first mold set may form the jaws 50 and 51 using the same retention of another type of exemplary endoskeleton 70 and sprocket 43 as previously described, although for this alternative, it may be contemplated that endoskeleton 70 may have a hand 71 that extends past the point where mouth 21a terminates into surface 21c. In other words, it may be contemplated that endoskeleton 70 permits for a portion of its relatively resilient face to go into that portion of VAGM 100 jaw 50 that couples the tongue 30. This alternative formation may be beneficial in this alternative molding methodology embodiment in that it provides a separate surface to which the same or different elastomer material may be molded to provide even further strength and/or anchoring to the tongue 30. So, when endoskeleton 70 and sprocket 43 are over-molded using previously described methods, the extended portion of endoskeleton 70 to which this alternative embodiment refers may not be over molded and remain exposed. This exposed portion of the endoskeleton 70 may be extended past the mouth 21a of the upper jaw 50 into the region that would properly be used for surface 21c of tongue 30. However, in this alternative embodiment, a second molding step may be applied to just this exposed portion of the endoskeleton 70 to enable formation of the tongue 30 using a different, e.g., more or less resilient, elastomer material. Thus, in this alternative embodiment, a VAGM 100 may be formed of two different elastomers in one integrated formation, albeit using multiple molding steps, to provide for increased strength of the flexible portions of VAGM 100.

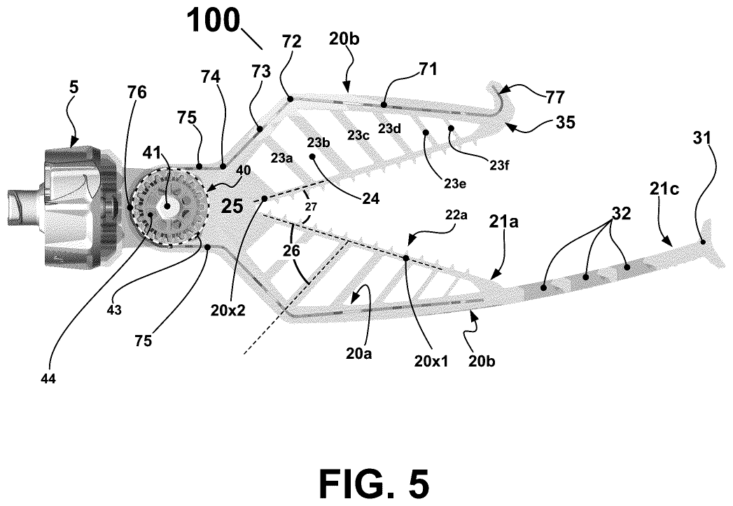

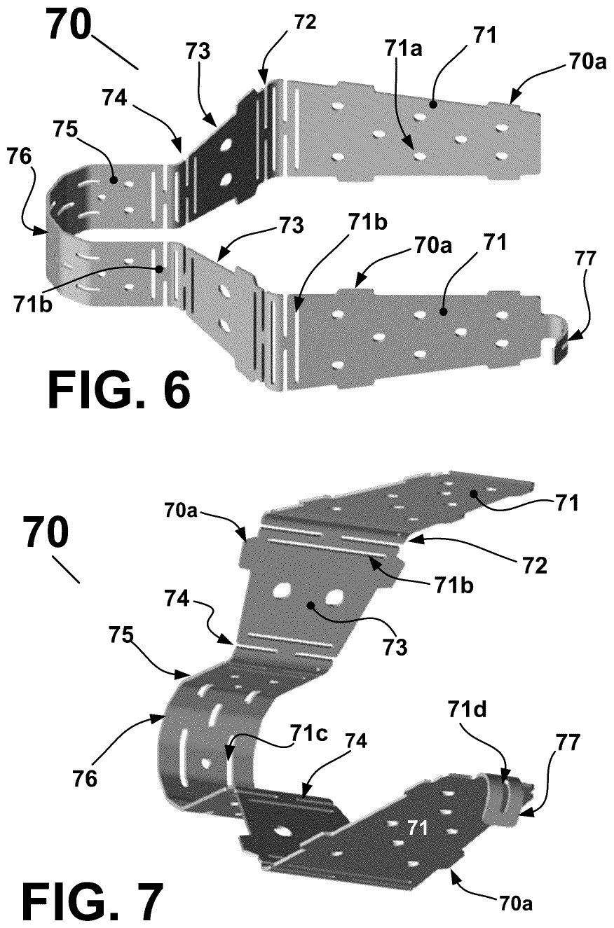

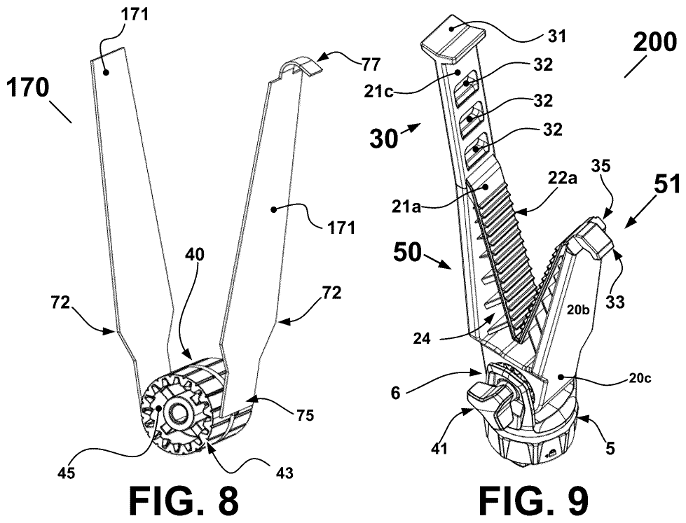

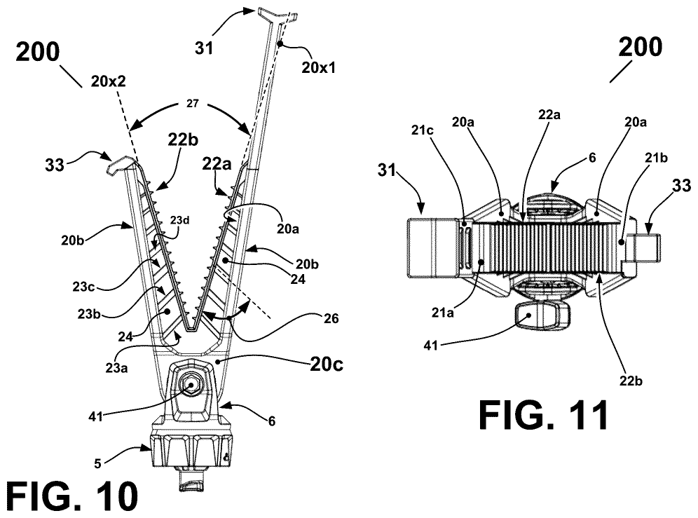

Referring to the exemplary embodiments depicted by FIGS. 8-10, another variant of an exemplary vehicular accessory gripping mechanism (“VAGM”) 200 may be illustrated comprised of endoskeleton 170. Notable differences between VAGM 200 and VAGM 100 may be the lack of web 25 in the final VAGM 200 and a clamp vertex 76 for endoskeleton 170. While endoskeleton may comprise numerous openings 71a, slats 71b, and tabs 70a, endoskeleton 170 may be comprised of unitary components 171 with geometry to be held stably within an over-molded elastomer and/or rugged and flexible material simultaneously with sprocket-type fulcrum 40. According to this exemplary alternative embodiment, the endoskeleton 170 may be substantially easier to manufacture than endoskeleton 70, with no reduction in functionality of the resulting VAGM 200 manufactured thereby. Each of the foregoing embodiments and disclosures related to VAGM 100 may be equally applicable to VAGM 200, including the angles 26 and 27 of the resultant VAGM 200. Thus, while VAGM 100 may comprise an endoskeleton 70 that is substantially U-shaped, VAGM 200 may have similar operational characteristics and functionalities while comprising an endoskeleton 170 that is discontinuous and/or not U-shaped in construction.

While the exemplary embodiments herein described refer to the use of one VAGM 100/200 to hold an object or objects simultaneously, it may be contemplated that increased holding stability may be achieved using two or more VAGM 100/200 in proper configurations. For example, a surface may comprise two VAGM 100/200 spaced apart from one another to enable simultaneous gripping of an object at multiple cross-sections to reduce the propensity of the object to shift or move during use, e.g., on vehicles meant to traverse rough and/or uneven terrain.

Many further variations and modifications may suggest themselves to those skilled in art upon making reference to above disclosure and foregoing interrelated and interchangeable illustrative embodiments, which are given by way of example only, and are not intended to limit the scope and spirit of the interrelated embodiments of the invention described herein.

1. A gripping mechanism, comprising:
a relatively resilient endoskeleton; and
a relatively flexible elastomer embedding the relatively resilient endoskeleton therein,
wherein the gripping mechanism comprises a first jaw formed from the relatively flexible elastomer that contains one part of the endoskeleton and a second jaw formed from the relatively flexible elastomer that contains an opposing part of the endoskeleton.

2. The gripping mechanism of claim 1, wherein the elastomer has a V-shaped configuration.

3. The gripping mechanism of claim 1, further comprising a sprocket between two portions of the U-shaped endoskeleton and also embedded within the elastomer.

4. The gripping mechanism of claim 3, wherein the elastomer has a V-shaped configuration.

5. The gripping mechanism of claim 1, wherein the relatively resilient endoskeleton further comprises at least one opening through its thickness and wherein the elastomer has at least one portion that passes through the at least one opening in the endoskeleton.

6. The gripping mechanism of claim 5, wherein the first jaw and the second jaw are configured to flex toward one another by a bending joint formed by a portion of the endoskeleton that couples the one part to the opposing part.

7. The gripping mechanism of claim 6, wherein the bending joint comprises a sprocket between the one part and the opposing part of the endoskeleton.

8. The gripping mechanism of claim 7, further comprising a web in which the sprocket is embedded and to which each of the elastomer material comprising the first jaw and the second jaw is integrally joined.

9. The gripping mechanism of claim 1, wherein the first jaw comprises a plurality of ribs interconnecting a first surface to a mouth.

10. The gripping mechanism of claim 9, wherein the second jaw comprises a plurality of ribs interconnecting a first surface to a mouth.

11. The gripping mechanism of claim 5, wherein at least one portion of the endoskeleton is exposed through the elastomer coating.

12. The gripping mechanism of claim 9, wherein at least one portion of the endoskeleton is exposed through the elastomer coating.

13. The gripping mechanism of claim 12, wherein each of the plurality of ribs is angled with respect to the mouth of the respective first jaw and second jaw in which it is found.

14. The gripping mechanism of claim 13, wherein each of the plurality of ribs is angled at an angle no greater than about 90 degrees.

15. The gripping mechanism of claim 14, wherein each of the plurality of ribs is angled at an angle no greater than about 60 degrees.

16. The gripping mechanism of claim 15, wherein each of the plurality of ribs is angled at an angle no greater than about 45 degrees.

17. The gripping mechanism of claim 5, further comprising a tongue integrally molded to one of the first jaw and the second jaw.

18. The gripping mechanism of claim 17, further comprising a hook integrally molded to whichever one of the first jaw and the second jaw does not have the tongue.

19. The gripping mechanism of claim 18, wherein the first jaw and the second jaw are more proximal to one another when the tongue is engaged to the hook as compared to when the tongue is disengaged from the hook.

20. The gripping mechanism of claim 12, further comprising a sprocket located at a bending point around which the first jaw and the second jaw bend and being embedded in the relatively flexible elastomer between at least two parts of the relatively resilient endoskeleton, wherein the first jaw and the second jaw each comprises a plurality of ribs interconnecting a first surface to a mouth, and the first jaw comprises a tongue and the second jaw comprises a hook configured to engage with the tongue to cause the first jaw and the second jaw to bend about the embedded sprocket.
